(19) United States
(12) Patent Application Publication
(10) Pub. No.: US 2025/0167828 A1
(43) Pub. Date: May 22, 2025

(54) CATV HYBRID FIBER-COAXIAL NETWORK AMPLIFIER PORTABLE WIRELESS ADAPTER

(71) Applicant: Applied Optoelectronics, Inc., Sugar Land, TX (US)

(72) Inventors: Yi WANG, Katy, TX (US); Ramesh NALLUR, Duluth, GA (US); Rafael CELEDON, Atlanta, GA (US)

(21) Appl. No.: 18/924,107

(22) Filed: Oct. 23, 2024

Related U.S. Application Data
(60) Provisional application No. 63/600,778, filed on Nov. 20, 2023.

(51) Int. Cl. H04B 3/06; H04H 20/78

(52) U.S. Cl. CPC H04B 3/06; H04H 20/78

(57) ABSTRACT

The present disclosure provides an RF line extender amplifier in a hybrid fiber-coaxial (HFC) network, the RF line extender amplifier including: RF amplifier circuitry; a service port communicatively coupled with the RF amplifier circuitry; and a wireless adapter communicatively coupled with the RF amplifier circuitry via the service port, the wireless adapter configured to communicatively couple with a user device to allow for wireless maintenance of the RF line extender amplifier.

### CROSS-REFERENCE TO RELATED APPLICATIONS

The present application claims the benefit of the filing date of U.S. Provisional Application Ser. No. 63/600,778, filed Nov. 20, 2023, the entire teachings of which application is hereby incorporated herein by reference.

### TECHNICAL FIELD

The present application relates generally to hybrid fiber and cable systems and, more particularly, to a CATV hybrid fiber-coaxial network amplifier portable wireless adapter.

### BACKGROUND

Broadband communication networks are used to provide high speed, high bandwidth transmissions over communication paths to and from devices in the network. In some broadband networks, such as hybrid fiber-coaxial (HFC) networks used for CATV, at least a portion of the communication path includes coaxial cables that carry both downstream and upstream radio frequency (RF) signals. In a CATV network, for example, the downstream RF signals may include video and IP data transmitted from a headend of the HFC network to subscriber devices and the upstream RF signals may include control and IP data transmitted from subscriber devices to the headend. In such broadband networks, there is often a desire to transmit additional information, such as control or status data, to and from devices in the network, for example, to have a more resilient and reliable broadband network and to be able to perform preemptive strategic maintenance to avoid outages.

In an HFC network, the coaxial distribution network may include RF line extender amplifiers to extend the transmission distance of the RF signals and thus extend the reach of the CATV services provided to subscriber locations. Providing direct communication with the RF line extender amplifiers is necessary for purposes of monitoring and diagnosing the RF amplifier circuitry by technicians in the field.

An RF line extender amplifier may include a diagnostic interface, such as a Universal Serial Bus (USB) port, to allow a user such as a technician to connect to the RF amplifier circuitry to diagnose issues and make adjustments. To use the diagnostic interface, the user must access the RF line extender amplifier, which is typically mounted on a transmission cable or a building, and connect a cable between the diagnostic interface in the RF line extender amplifier and a user device, such as a laptop computer or tablet computer. This requires the user and the user device to be exposed to inclement weather conditions, which could lead to injury to the technician or damage to the equipment. Accordingly, there is a need for a wireless connection between the user device and the RF line extender amplifier. Disclosed herein is a wireless adapter that allows a user to connect a user device to the RF line extender amplifier wirelessly, and to diagnose the RF amplifier circuitry from, for example, the passenger compartment of the user's service vehicle.

### BRIEF DESCRIPTION OF THE DRAWINGS

Reference should be made to the following detailed description which should be read in conjunction with the following figures, wherein like numerals represent like parts.

FIG. 1 is a schematic diagram of a hybrid fiber-coaxial (HFC) network used for CATV consistent with the present disclosure.

FIG. 2 is a schematic diagram of a remote PHY (R-PHY) HFC network configured for low data rate, low power, bi-directional transmissions between network devices and a headend consistent with the present disclosure.

FIG. 3 is a block diagram of an illustrative example of RF line extender amplifiers for a CATV distribution system incorporating wireless adapters consistent with the present disclosure.

FIG. 4A is a functional block diagram of an illustrative example of a wireless adapter for an RF line extender amplifier consistent with the present disclosure.

FIG. 4B is an example of the wireless adapter for an RF line extender amplifier of FIG. 4A consistent with the present disclosure.

FIG. 5 is an example of an RF line extender amplifier incorporating a wireless adapter consistent with the present disclosure.

FIGS. 6A and 6B are an example of a maintenance console for RF amplifier circuitry using a Graphical User Interface (GUI) consistent with the present disclosure.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, it may be appreciated that the phraseology and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of a particular exemplary embodiment may be equally applied to any other exemplary embodiment(s) of this disclosure as suitable. In other words, features between the various exemplary embodiments described herein are interchangeable, and not exclusive.

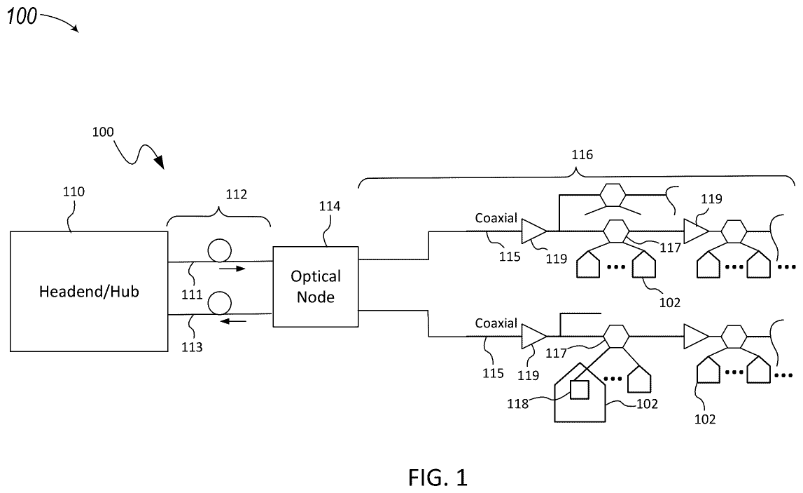

FIG. 1 illustrates an example of a hybrid fiber-coaxial (HFC) network 100 used for CATV, which may implement systems and methods for low data rate, low power, bi-directional transmissions, consistent with embodiments of the present disclosure. The systems and methods for low data rate, low power, bi-directional transmissions may be implemented, for example, to communicate with an optical node 114 and/or line extender RF amplifiers 119 in the HFC network 100. In general, the HFC network 100 is capable of delivering both cable television programming (i.e., video) and IP data services (e.g., internet and voice over IP) to customers or subscribers 102 through the same fiber optic cables and coaxial cables (i.e., trunk lines). Such an HFC network 100 is commonly used by service providers, such as Comcast Corporation, to provide combined video, voice, and broadband internet services to the subscribers 102. Although example embodiments of HFC networks are described herein based on various standards (e.g., DOCSIS), the concepts described herein may be applicable to other embodiments of CATV networks using other standards.

Multiple cable television channels and IP data services (e.g., broadband internet and voice over IP) may be delivered together simultaneously in the HFC network 100 by transmitting signals using frequency division multiplexing over a plurality of physical channels across a CATV channel spectrum. In a CATV channel spectrum, some of the physical channels may be allocated for cable television channels and other physical channels may be allocated for IP data services. Other channel spectrums and bandwidths may also be used and are within the scope of the present disclosure.

In addition to the primary signals being carried downstream (also referred to as forward signals) to deliver the video and IP data to the subscribers 102, the HFC network 100 may also carry primary signals (e.g., IP data or control signals) upstream from the subscribers (also referred to as reverse signals), thereby providing bi-directional communication over the trunks. According to one example, the signal spectrum for the reverse signals carried upstream may be up to 600 MHZ.

The HFC network 100 generally includes a headend/hub 110 connected via optical fiber trunk lines 112 to one or more optical nodes 114, which are connected via a coaxial cable distribution network 116 to customer premises equipment (CPE) 118 at subscriber locations 102. The headend/hub 110 receives, processes, and combines the content (e.g., broadcast video, narrowcast video, and internet data) to be carried over the optical fiber trunk lines 112 as optical signals. The optical fiber trunk lines 112 include forward path optical fibers 111 for carrying downstream optical signals from the headend/hub 110 and return or reverse path optical fibers 113 for carrying upstream optical signals to the headend/hub 110. The optical nodes 114 provide an optical-to-electrical interface between the optical fiber trunk lines 112 and the coaxial cable distribution network 116. The optical nodes 114 thus receive downstream optical signals and transmit upstream optical signals and transmit downstream (forward) RF electrical signals and receive upstream (reverse) RF electrical signals.

The coaxial cable distribution network 116 includes coaxial cables 115 including trunk coaxial cables connected to the optical nodes 114 and feeder coaxial cables connected to the trunk coaxial cables. Subscriber drop coaxial cables are connected to the distribution coaxial cables using taps 117 and are connected to customer premises equipment 118 at the subscriber locations 102. The customer premises equipment 118 may include set-top boxes for video and cable modems for data. One or more line extender RF amplifiers 119 may also be coupled to the coaxial cables 115 for amplifying the forward signals (e.g., CATV signals) being carried downstream to the subscribers 102 and for amplifying the reverse signals being carried upstream from the subscribers 102. In this embodiment, the optical node 114 and/or the line extender RF amplifiers 119 may include transponders and the headend/hub 110 may include a gateway device to implement the low data rate, low power, bi-directional transmissions together with the downstream and upstream primary signals, which have a higher bandwidth and power.

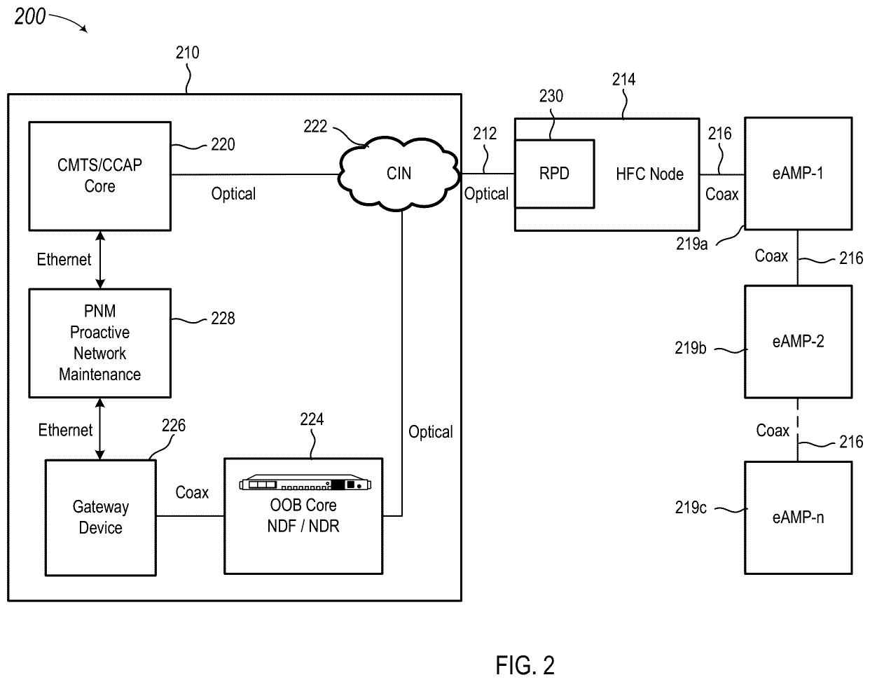

FIG. 2 shows an implementation of a system for low data rate, low power, bi-directional transmissions in a remote PHY type HFC network 200. This HFC network 200 also includes a headend 210 coupled to an HFC node 214 using optical fiber 212 and includes RF line extender amplifiers 219a-c coupled to the HFC node 214 using coaxial cables 216, similar to the HFC network 100 described above and shown in FIG. 1. In this embodiment of the HFC network 200, low data rate, low power, bi-directional transmissions may be implemented in the RF line extender amplifiers 219a-c, for example, to communicate with a proactive network maintenance (PNM) system in the headend. In this HFC network 200, digital communication is provided over the optical fiber 212 between the headend 210 and the HFC node 214 and the HFC node 214 includes a remote PHY device (RPD) 230 to handle the digital communications.

In this embodiment of the HFC network 200, the headend 210 includes an integrated Cable Modem Termination System (CMTS) or Converged Cable Access Platform (CCAP) core 220 coupled to a converged interconnected network (CIN) 222. The CCAP core 220 and the CIN 222 provide digitized optical communication with the RPD 230 in the HFC node 214. The headend 210 also includes a gateway device 226 to establish the low data rate, low power bi-directional transmissions. In this embodiment, the analog low data rate, low power bi-directional transmissions are digitized for communication between the CIN 222 and the RPD 230 in the HFC node 214. The RPD 230 converts upstream signals from analog to digital and converts downstream signals from digital to analog, and the headend 210 may include an out-of-band (OOB) core 224 coupled to the gateway device 226 to handle the A/D and D/A conversion in the headend 210 for the low data rate, low power bi-directional transmissions.

The OOB core 224 may use known technologies and standards in the DOCSIS R-PHY specifications referred to as the OOB (out-of-band) communication protocols, which are further defined in the remote out-of-band (CM-SP-R-OOB) specification. As defined in the CM-SP-R-OOB specification, Narrowband Digital Forward (NDF) and Narrowband Digital Return (NDR) digitizes a small portion of the spectrum and sends the digital samples as payload within packets that traverse between the CMTS/CCAP core 220 and the RPD 230. This approach works with any type of OOB signal as long as the signal can be contained within the defined pass bands.

In the embodiment of the HFC network 200 described above, the headend 210 may include a PNM system 228 coupled to the CMTS 220 and the gateway device 226. The PNM system 228 may be used by cable operators to perform strategic maintenance of a network preemptively to avoid long outages and to have a more resilient and reliable broadband network. Commands and/or data used by the PNM system 228 may be transmitted and received via the low data rate, low power bi-directional transmissions established using the gateway device 226 to provide network maintenance. The PNM system 228 may include existing PNM systems known to those skilled in the art. The headend 210 may use the gateway device 226 and the low data rate, low power bi-directional transmissions to communicate the commands and/or data for managing a large number of network devices, such as nodes and RF line extender amplifiers, in the HFC network 200 using existing network management and control systems. The systems and methods for low data rate, low power bi-directional transmissions, consistent with embodiments of the present disclosure, thus provide a relatively simple, reliable, and low cost solution for monitoring, controlling, and managing broadband networks without detectable interference with the primary broadband signals.

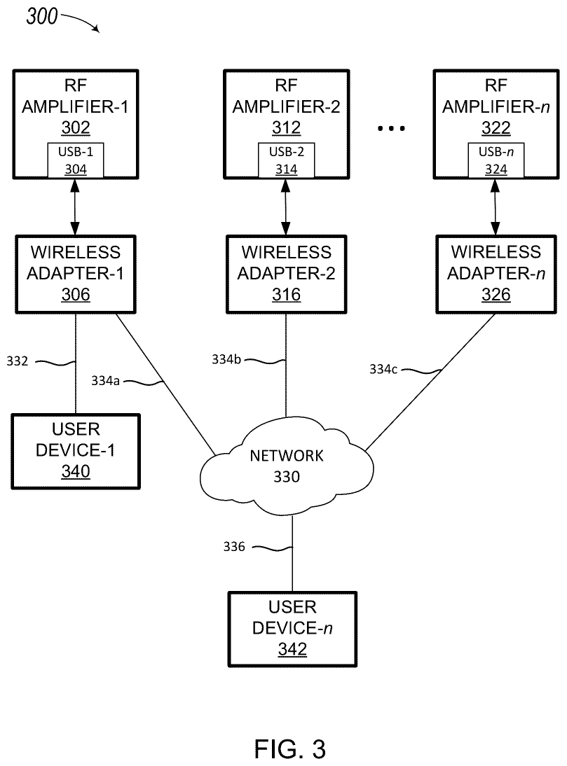

FIG. 3 is a block diagram of an illustrative example of a system 300 of RF line extender amplifiers for a CATV distribution system incorporating wireless adapters consistent with the present disclosure. FIG. 3 includes RF line extender amplifier-1 302, RF line extender amplifier-2 312, and RF line extender amplifier-n 322. Although three RF line extender amplifiers are shown in the example of FIG. 3, it should be understood that any number of RF line extender amplifiers may be supported by the system of FIG. 3. Each of the RF line extender amplifier-1 302, the RF line extender amplifier-2 312, and the RF line extender amplifier-n 322 may be, for example, the RF line extender amplifier 219a, 219b, or 219c of FIG. 2.

Each RF line extender amplifier includes a service port, which in the example of FIG. 3 is a USB interface. The RF line extender amplifier-1 302 includes USB-1 304, the RF line extender amplifier-2 312 includes USB-2 314, and the RF line extender amplifier-n 322 includes USB-n 324. In an embodiment, the USB-1 304, the USB-2 314, and the USB-n 324 interfaces may each be a USB Type-A port (USB-A). In another embodiment, the USB-1 304, the USB-2 314, and the USB-n 324 interfaces may each be a USB Type-C port (USB-C). In yet another embodiment, different models or types of RF line extender amplifiers may use other types of USB interfaces.

The system 300 of FIG. 3 includes a wireless adapter-1 306 communicatively coupled with the RF line extender amplifier-1 302 via the USB-1 304, a wireless adapter-2 316 communicatively coupled with the RF line extender amplifier-2 312 via the USB-2 314, and a wireless adapter-n 326 communicatively coupled with the RF line extender amplifier-n 322 via the USB-n 324.

The system 300 of FIG. 3 includes user device-1 340 and user device-n 342. The user device-1 340 and the user device-n 342 may each be a standalone computing device, a mobile computing device, or any other electronic device or computing system capable of receiving, sending, and processing data. In an embodiment, the user device-1 340 and the user device-n 342 can each be a laptop computer, a tablet computer, a netbook computer, a personal computer (PC), a desktop computer, a smart phone, or any programmable electronic device capable of communicating with other computing devices (not shown) within the system 300 via the network 330. Typically, the user device-1 340 and the user device-n 342 are devices used by users such as service technicians to monitor and diagnose issues on, and make configuration changes to, the RF line extender amplifiers of system 300.

In the example system 300, the user device-1 340 may be communicatively coupled with RF line extender amplifier-1 302 via the wireless adapter-1 306 using a peer-to-peer (P2P) network connection 332. A P2P network is group of computers, each of which acts as a node for sharing files within the group. In its simplest form, a P2P network is created when two or more computing devices are connected and share resources without going through a separate server computer. In the example of FIG. 3, the user of the user device-1 340 has inserted the wireless adapter-1 306 into a service port, e.g., the USB-1 304 of the RF line extender amplifier-1 302. The user of the user device-1 340 then connects to the RF line extender amplifier-1 302 using the P2P network connection 332 between the user device-1 340 and the RF line extender amplifier-1 302. The user of the user device-1 340 may then proceed to monitor the RF line extender amplifier-1 302, and perform diagnostic, maintenance, reconfiguration, update, and repair procedures as necessary.

The wireless adapter-1 306, the wireless adapter-2 316, the wireless adapter-n 326, and the user device-n 342, may optionally be connected to the network 330 via a network connection 334a, a network connection 334b, and a network connection 334c, respectively. The network 330 can be, for example, a telecommunications network, a local area network (LAN), a wide area network (WAN), such as the Internet, or a combination of the three, and can include wired, wireless, or fiber optic connections. The network 330 can include one or more wired and/or wireless networks that are capable of receiving and transmitting data, voice, and/or video signals, including multimedia signals that include voice, data, and video information. In general, the network 330 can be any combination of connections and protocols that will support communications between the RF line extender amplifier-1 302, the RF line extender amplifier-2 312, the RF line extender amplifier-n 322, the user device-n 342, and other computing devices (not shown) within the system 300.

As shown in FIG. 3, a wireless device coupled with an RF amplifier, such as wireless adapter-1 306 coupled with the RF line extender amplifier-1 302, may connect to one or more user devices via either the P2P network connection 332, the network 330 via the network connection 334a, or both simultaneously.

In the example system 300, the user device-n 342 may be communicatively coupled with the RF line extender amplifier-1 302 via the wireless adapter-1 306, the RF line extender amplifier-2 312 via the wireless adapter-2 316, and/or the RF line extender amplifier-n 322 via the wireless adapter-n 326 over the network 330. In the example of FIG. 3, each of the RF line extender amplifier-1 302, the RF line extender amplifier-2 312, and the RF line extender amplifier-n 322 have the wireless adapter-1 306, the wireless adapter-2 316, and the wireless adapter-n 326, respectively, inserted into their respective service ports, e.g., the USB-1 304 of the RF line extender amplifier-1 302, the USB-2 314 of the RF line extender amplifier-2 312, and the USB-n 324 of the RF line extender amplifier-n 322, respectively. The user of the user device-n 342 then connects to the any of the RF line extender amplifier-1 302, the RF line extender amplifier-2 312, and/or the RF line extender amplifier-n 322 using the network 330.

The user of the user device-n 342 may then proceed to monitor the RF line extender amplifier-1 302, the RF line extender amplifier-2 312, and/or the RF line extender amplifier-n 322, and perform diagnostic, maintenance, reconfiguration, update, and repair procedures, as necessary.

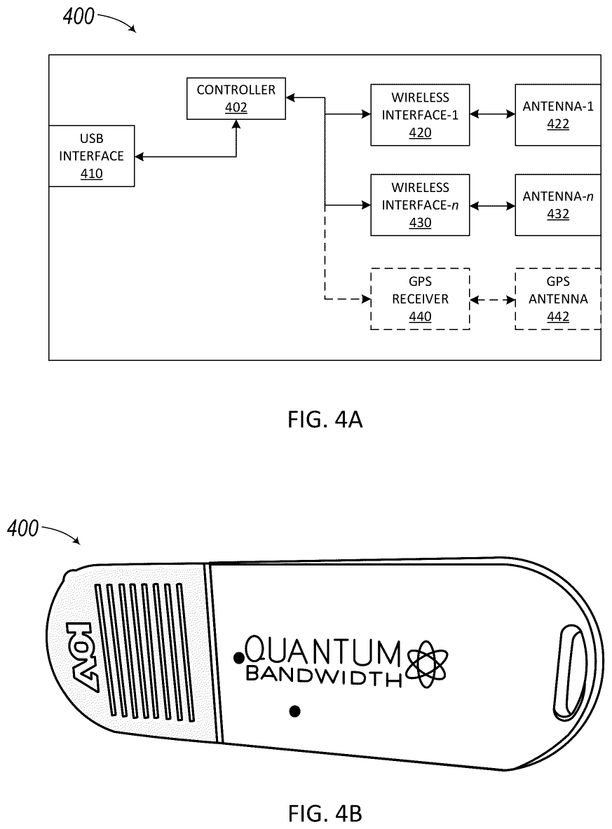

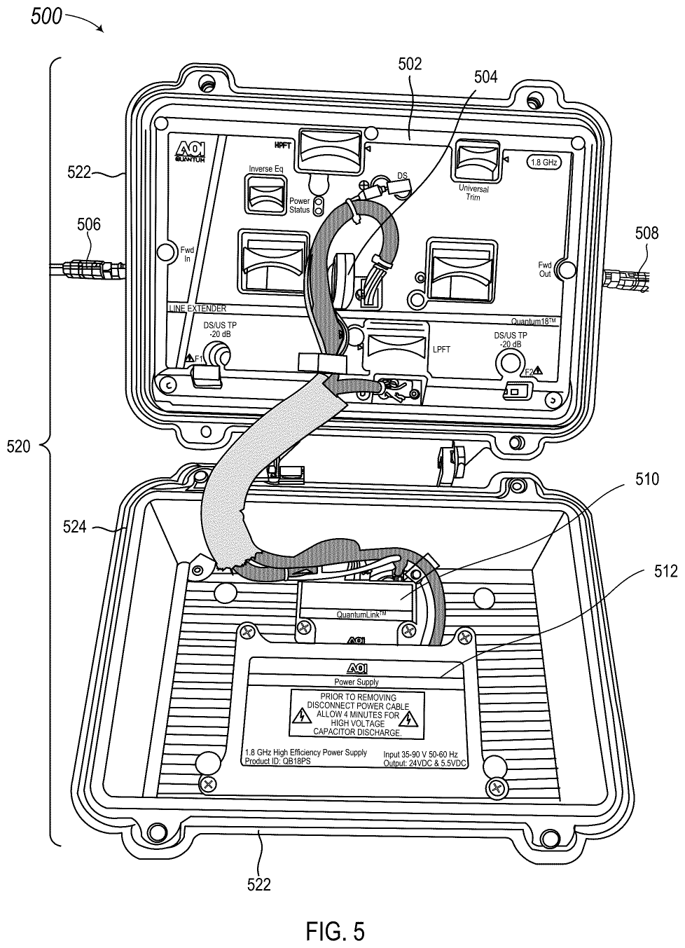

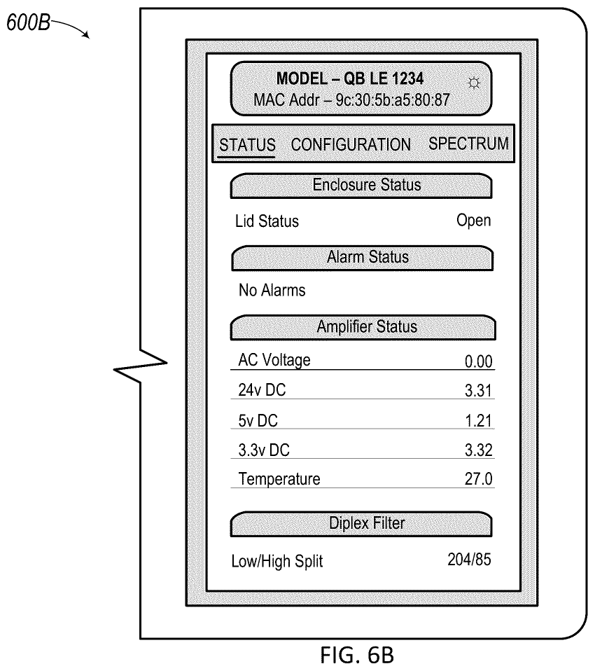

FIG. 4A is a functional block diagram of an illustrative example of a wireless adapter 400 for an RF line extender amplifier consistent with the present disclosure. In an embodiment, the wireless adapter 400 may allow for monitoring and controlling the RF line extender amplifier per the SCTE standard SP 923. An example of a maintenance console for the RF line extender amplifier is shown in FIGS. 6A and 6B below.

The wireless adapter 400 may include a controller 402 communicatively coupled with a service port interface 410, one or more wireless interfaces wireless interface-1 420 through wireless interface-n 430, and optionally a Global Positioning System (GPS) receiver 440. The controller 402 may be configured to allow communication between the service port interface 410 and any or all of wireless interface-1 420 through the wireless interface-n 430. While the illustrative example of FIG. 4A shows two wireless interfaces, the wireless adapter 400 may include additional wireless interfaces as may be desirable. In an embodiment, the service port interface 410 may be a USB-A port. In another embodiment, the service port interface 410 may be a USB-C port. In yet another embodiment, the service port interface 410 may be any other type of communications interface as may be appropriate. In an embodiment, the communications port may be a USB port and may be configured to function as a USB-slave device. In another embodiment, the communications port may be a USB port and may be configured to function as a USB-host device. In yet another embodiment, the communications port may be a USB port and may be configured to function as either a USB-slave device or a USB-host device.

The wireless interface-1 420 is electrically coupled with antenna-1 422 and configured to transmit and receive wireless signals over antenna-1 422, and the wireless interface-n 430 is electrically coupled with antenna-n 432 and configured to transmit and receive wireless signals over antenna-n 432. In an embodiment, any of the wireless interface-1 420 through the wireless interface-n 430 may be an 802.11 wireless (Wi-Fi) interface. In an embodiment, any of the wireless interface-1 420 through the wireless interface-n 430 may operate over the 2.4 GHz Wi-Fi band. In another embodiment, any of the wireless interface-1 420 through the wireless interface-n 430 may operate over the 5 GHz Wi-Fi band. In yet another embodiment, any of the wireless interface-1 420 through the wireless interface-n 430 may operate over either or both of the 2.4 GHZ and 5 GHz Wi-Fi bands. In an embodiment, any of the wireless interface-1 420 through the wireless interface-n 430 may include a Wi-Fi website server to allow access to any user device having a web browser, such as user device-1 340 or user device-n 342 from FIG. 3, to access the RF line extender interface via any of the wireless interface-1 420 through the wireless interface-n 430.

In an embodiment, any of the wireless interface-1 420 through the wireless interface-n 430 may be a Bluetooth interface. In an embodiment, any of the wireless interface-1 420 through the wireless interface-n 430 may be a standard Bluetooth interface, e.g., Bluetooth 5. In another embodiment, any of the wireless interface-1 420 through the wireless interface-n 430 may be a Bluetooth Low Energy (BLE) interface. In yet another embodiment, any of the wireless interface-1 420 through the wireless interface-n 430 may be a Bluetooth Mesh interface.

The optional GPS receiver 440 is electrically coupled with a GPS antenna 442. The controller 402 may be configured to receive global position information from the GPS receiver 440 which may be used, for example, to determine a geographic location, a specific model number, or a serial number of the RF line extender amplifier from a database of installed RF line extender amplifiers based on global position information.

FIG. 4B is an example of the wireless adapter 400 of FIG. 4A consistent with the present disclosure. The example of FIG. 4B is for illustrative purposes only. Many other configurations of the wireless adapter 400 are possible, as would be known to a person of skill in the art.

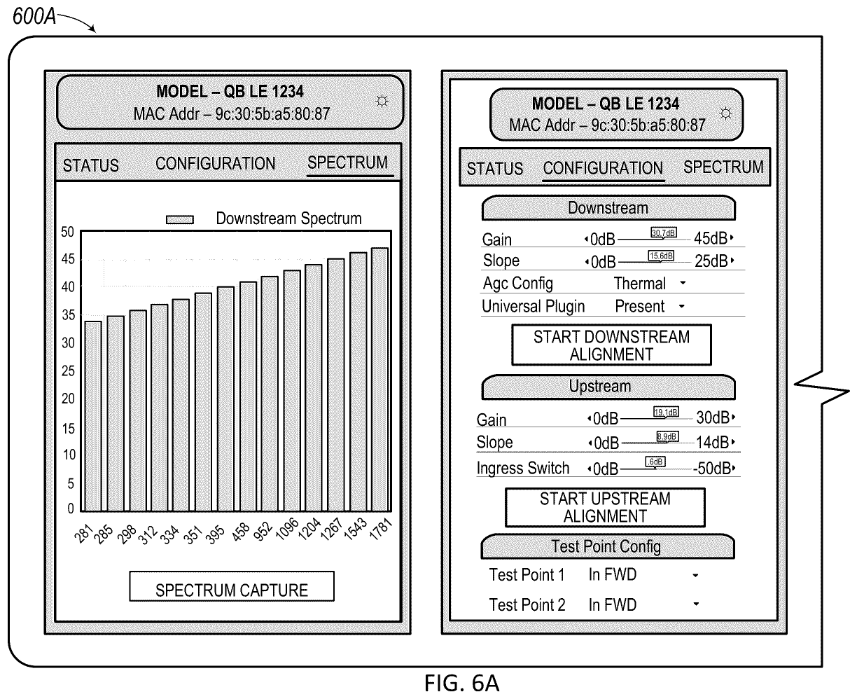

FIG. 5 is an example of an RF line extender amplifier 500 incorporating a wireless adapter consistent with the present disclosure. In the example of FIG. 5, RF line extender amplifier 500 includes an enclosure 520, which is comprised of an enclosure lid 522 and an enclosure base 524, RF amplifier circuitry 502 with a wireless adapter 504 inserted into a USB service port. The RF line extender amplifier 500 is electrically coupled with an incoming HFC cable 506 and an outgoing HFC cable 508. The RF line extender amplifier 500 also includes a remote management module 510. The RF line extender amplifier 500 is powered by a power supply 512.

FIGS. 6A and 6B are an example of a maintenance console 600 for RF amplifier circuitry using a Graphical User Interface (GUI) consistent with the present disclosure. In an embodiment, an RF line extender amplifier, for example, RF line extender amplifier-1 302 of FIG. 3, may include a maintenance console that may be accessed by a user, such as a maintenance technician, to perform diagnostic, maintenance, reconfiguration, update, and repair procedures as necessary to the RF amplifier circuitry in the RF line extender amplifier. In an embodiment, the maintenance console may include a GUI to display information about the RF amplifier circuitry and to provide one or more controls to allow the user to control the features of the RF amplifier circuitry and to adjust the parameters of the RF amplifier circuitry.

In an embodiment, the GUI may be a web GUI that may be accessed over a network, e.g., network 330 of FIG. 1. In an embodiment, the GUI may be an app executed on a user device, e.g., user device-1 340 of FIG. 1. In some embodiments, the web GUI and the app GUI may be the same GUI. In some other embodiments, the web GUI and the app GUI may be different.

In an embodiment, the GUI may include, but is not limited to, status information, configuration information, and spectrum information. The status information may include, but is not limited to, enclosure status, alarm status, amplifier status, and diplex filter status.

In an embodiment, the enclosure status may include a lid status, i.e., an indication whether the lid of the RF line extender amplifier enclosure, such as the enclosure lid 522 of FIG. 5, is open or closed. In an embodiment, the enclosure status may include an alarm status. The alarm status may include an indication that no alarms are currently pending in the RF line extender amplifier, as shown in FIGS. 6A and 6B. In an embodiment, if any alarms are currently pending in the RF line extender amplifier, the alarm status may include a list of pending alarms and may indicate the type of alarm and may also include a further description of the alarm for each alarm that currently exists.

In an embodiment, the enclosure status may include an amplifier status, which may indicate the current functional status of the RF amplifier circuitry, such as the input power to the RF amplifier circuitry. This may include the AC voltage, and any required DC voltages, such as 24 volt DC, 5 volt DC, and 3.3 volt DC. The amplifier status may also include the temperature of the RF amplifier circuitry.

In an embodiment, the diplex filter status may include the high/low split values of the RF amplifier circuitry.

In an embodiment, the spectrum information may include downstream spectrum information and upstream spectrum information. The downstream spectrum information may include, but is not limited to, gain; slope; automatic gain control configuration; and universal plugin status. The gain is the amplification, or boost, of the RF amplifier circuitry and is typically a ratio of output power to the input power and is measured in decibels (dB). The slope is a measure of the attenuation of higher-frequency signals versus lower-frequency signals.

In an embodiment, the downstream spectrum information may include, but is not limited to, gain; slope; and ingress switch status.

In an embodiment, the spectrum information may include controls to start a downstream alignment procedure; and controls to start an upstream alignment procedure.

According to one aspect of the disclosure there is thus provided an RF line extender amplifier in a hybrid fiber-coaxial (HFC) network, the RF line extender amplifier including: RF amplifier circuitry; a service port communicatively coupled with the RF amplifier circuitry; and a wireless adapter communicatively coupled with the RF amplifier circuitry via the service port, the wireless adapter configured to communicatively couple with a user device to allow for wireless maintenance of the RF line extender amplifier.

According to another aspect of the disclosure, there is provided a system for wireless maintenance of an RF line extender amplifier in a hybrid fiber coaxial (HFC) network, the system including: RF amplifier circuitry; a service port; a wireless adapter communicatively coupled with the RF amplifier circuitry via the service port; and a user device communicatively coupled with the wireless adapter and including a maintenance console for the RF amplifier circuitry. The maintenance console is configured to: receive status information from the RF amplifier circuitry; and send control information to the RF amplifier circuitry.

According to yet another aspect of the disclosure, there is provided a system for wireless maintenance of an RF line extender amplifier in a hybrid fiber coaxial (HFC) network, the system including: RF amplifier circuitry; a service port; a wireless adapter communicatively coupled with the RF amplifier circuitry via the service port, the wireless adapter including a Universal Serial Bus (USB) port and at least one of an 802.11 wireless (Wi-Fi) interface, a Bluetooth interface, and a Global Positioning System (GPS) receiver; and a user device communicatively coupled with the wireless adapter and including a maintenance console Graphical User Interface (GUI) for the RF amplifier circuitry. The maintenance console GUI is configured to: receive status information and configuration information from the RF amplifier circuitry, where the status information and configuration information includes at least one of enclosure status, alarm status, amplifier status, diplex filter status, downstream spectrum information and upstream spectrum information; and send control information to the RF amplifier circuitry.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto.

Embodiments of the methods described herein may be implemented using a controller, processor, and/or other programmable device. To that end, the methods described herein may be implemented on a tangible, non-transitory computer readable medium having instructions stored thereon that when executed by one or more processors perform the methods. The storage medium may include any type of tangible medium, for example, semiconductor devices such as read-only memories (ROMs), random access memories (RAMs) such as dynamic and static RAMs, erasable programmable read-only memories (EPROMs), electrically erasable programmable read-only memories (EEPROMs), flash memories, or any type of media suitable for storing electronic instructions.

It will be appreciated by those skilled in the art that any block diagrams herein represent conceptual views of illustrative circuitry embodying the principles of the disclosure. Similarly, it will be appreciated that any block diagrams, flow charts, flow diagrams, state transition diagrams, pseudocode, and the like represent various processes which may be substantially represented in computer readable medium and so executed by a computer or processor, whether or not such computer or processor is explicitly shown. Software modules, or simply modules which are implied to be software, may be represented herein as any combination of flowchart elements or other elements indicating performance of process steps and/or textual description. Such modules may be executed by hardware that is expressly or implicitly shown.

The functions of the various elements shown in the figures, including any functional blocks labeled as a controller or processor, may be provided through the use of dedicated hardware as well as hardware capable of executing software in association with appropriate software. The functions may be provided by a single dedicated processor, by a single shared processor, or by a plurality of individual processors, some of which may be shared. Moreover, explicit use of the term controller or processor should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

The term “coupled” as used herein refers to any connection, coupling, link, or the like by which signals carried by one system element are imparted to the “coupled” element. Such “coupled” devices, or signals and devices, are not necessarily directly connected to one another and may be separated by intermediate components or devices that may manipulate or modify such signals.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art.

What is claimed is:

1. An RF line extender amplifier in a hybrid fiber-coaxial (HFC) network, the RF line extender amplifier comprising:
RF amplifier circuitry;
a service port communicatively coupled with the RF amplifier circuitry; and
a wireless adapter communicatively coupled with the RF amplifier circuitry via the service port, the wireless adapter configured to communicatively couple with a user device to allow for wireless maintenance of the RF line extender amplifier.

2. The RF line extender amplifier of claim 1, wherein the service port is a Universal Serial Bus (USB) port.

3. The RF line extender amplifier of claim 2, wherein the USB port is a USB Type-A port.

4. The RF line extender amplifier of claim 2, wherein the USB port is a USB Type-C port.

5. The RF line extender amplifier of claim 1, wherein the wireless adapter further comprises:
a service port interface; and
one or more wireless interfaces.

6. The RF line extender amplifier of claim 5, wherein the service port interface is a USB port.

7. The RF line extender amplifier of claim 6, wherein the USB port is a USB Type-A port.

8. The RF line extender amplifier of claim 6, wherein the USB port is a USB Type-C port.

9. The RF line extender amplifier of claim 5, wherein at least one of the one or more wireless interfaces is an 802.11 wireless (Wi-Fi) interface.

10. The RF line extender amplifier of claim 9, wherein the Wi-Fi interface operates over a 2.4 GHz band.

11. The RF line extender amplifier of claim 9, wherein the Wi-Fi interface operates over a 5 GHz band.

12. The RF line extender amplifier of claim 5, wherein the wireless adapter further comprises a Global Positioning System (GPS) receiver.

13. A system for wireless maintenance of an RF line extender amplifier in a hybrid fiber-coaxial (HFC) network, the system comprising:
RF amplifier circuitry;
a service port;
a wireless adapter communicatively coupled with the RF amplifier circuitry via the service port; and
a user device communicatively coupled with the wireless adapter and including a maintenance console for the RF amplifier circuitry, the maintenance console configured to:
receive status information from the RF amplifier circuitry; and
send control information to the RF amplifier circuitry.

14. The system of claim 13, wherein the maintenance console includes a Graphical User Interface (GUI).

15. The system of claim 13, wherein the service port is a Universal Serial Bus (USB) port.

16. The system of claim 14, wherein the wireless adapter further comprises:
a service port interface; and
one or more wireless interfaces.

17. The system of claim 16, wherein the service port interface is a USB type-A port.

18. The system of claim 16, wherein the service port interface is a USB type-C port.

19. The system of claim 16, wherein at least one of the one or more wireless interfaces is an 802.11 wireless (Wi-Fi) interface.

20. The system of claim 19, wherein at least one of the one or more wireless interfaces is a Bluetooth interface.

21. The system of claim 20, wherein the Bluetooth interface is selected from the group consisting of standard Bluetooth, Bluetooth Low Energy (BLE), and Bluetooth Mesh.

22. The system of claim 16, wherein the wireless adapter further comprises a Global Positioning System (GPS) receiver.

23. The system of claim 14, wherein the GUI includes at least one of status information, configuration information, and spectrum information.

24. The system of claim 23, wherein the status information includes at least one of enclosure status, alarm status, amplifier status, and diplex filter status.

25. The system of claim 23, wherein the spectrum information further comprises:
downstream spectrum information, the downstream spectrum information including at least one of gain; slope; automatic gain control configuration; and universal plugin status.

26. The system of claim 23, wherein the spectrum information further comprises:
upstream spectrum information, the upstream spectrum information including at least one of gain; slope; and ingress switch status.

27. The system of claim 23, wherein the spectrum information further comprises:
a first controls to start a downstream alignment procedure; and
a second controls to start an upstream alignment procedure.

28. The system of claim 20, wherein the user device communicatively couples with the wireless adapter via both the Wi-Fi interface and the Bluetooth interface.

29. The system of claim 14, wherein the GUI is an app executed on the user device.

30. The system of claim 19, wherein the GUI is a web GUI accessed via the Wi-Fi interface.

31. A system for wireless maintenance of an RF line extender amplifier in a hybrid fiber-coaxial (HFC) network, the system comprising:
RF amplifier circuitry;
a service port;
a wireless adapter communicatively coupled with the RF amplifier circuitry via the service port, the wireless adapter including a service port interface and at least one of an 802.11 wireless (Wi-Fi) interface, a Bluetooth interface, and a Global Positioning System (GPS) receiver; and
a user device communicatively coupled with the wireless adapter and including a maintenance console Graphical User Interface (GUI) for the RF amplifier circuitry, the maintenance console GUI configured to:
receive status information and configuration information from the RF amplifier circuitry, wherein the status information and configuration information includes at least one of enclosure status, alarm status, amplifier status, diplex filter status, downstream spectrum information and upstream spectrum information; and
send control information to the RF amplifier circuitry.
